(19) United States
(12) Patent Application Publication
(10) Pub. No.: US 2026/0045525 A1
(43) Pub. Date: Feb. 12, 2026

(54) METHOD FOR MANUFACTURING A BIPOLAR PLATE

(71) Applicant: Robert Bosch GmbH, Stuttgart (DE)

(72) Inventors: Thorsten Laube, Hirschaid (DE); Andreas Heider, Stuttgart (DE); Axel Bormann, Bamberg (DE); Johannes Hagen, Stegaurach (DE); Paul Veltmans, Nuenen (NL); Roland Gauch, Renningen (DE); Thorsten Bauer, Memmelsdorf (DE)

(21) Appl. No.: 18/998,638

(22) PCT Filed: Jun. 27, 2023
(86) PCT No.: PCT/EP2023/067359

§ 371 Date: Jan. 27, 2025

(30) Foreign Application Priority Data
Jul. 27, 2022 (DE) 10 2022 207 666.4

(51) Int. Cl. H01M 8/0297; B23K 26/244; C25B 1/04; C25B 9/65; C25B 9/75; H01M 8/0254; H01M 8/0258; H01M 8/0267

(52) U.S. Cl. CPC H01M 8/0297; B23K 26/244; C25B 1/04; C25B 9/65; C25B 9/75; H01M 8/0254; H01M 8/0258; H01M 8/0267

(57) ABSTRACT

The invention relates to a method for manufacturing a bipolar plate (10, 51) for an electrochemical cell unit (53) for converting electrochemical energy into electrical energy as a fuel cell unit (1) and/or for converting electrical energy into electrochemical energy as an electrolytic cell unit (49) having stacked electrochemical cells (52), the method comprising the steps of: providing a first plate 64) and a second plate (65), stacking the first plate (64) and the second plate (65) on top of one another such that inner surfaces (66) of the first and second plate (64, 65) lie on top of one another, applying contact forces to the first and second plates (64, 65) by means of negative pressure in a negative pressure chamber (104) relative to an ambient pressure so that, as a result of the contact forces applied by the ambient pressure, the inner surfaces (66) of the first and second plate (64, 65) lie on top of one another with an additional compression force in a contact region (68) due to the applied contact forces, producing at least one welded joint (69) between the first and second plate (64, 65) by means of a laser beam (74), forming connection channels (89) for process fluids in the first and/or second plate (64, 65), the channels opening into fluid openings (41) in the bipolar plates (10), 51) and into channels (12, 13, 14) for process fluids in the bipolar plates (10, 51), forming connection openings (93) in the first and/or second plate (64, 65) which connect the connection channels (89) to the channels (12, 13, 14) for process fluids in the bipolar plates (10, 51), the connection openings (93) being formed in the first and/or second plate (64, 65) by means of a laser beam (74).

### BACKGROUND

The present invention relates to a method for manufacturing a bipolar plate for an electrochemical cell unit, a method for manufacturing an electrochemical cell unit, and an electrochemical cell unit according to the disclosure.

Fuel cell units acting as galvanic cells convert continuously supplied fuel and oxidizing agent into electrical energy and water by means of redox reactions at an anode and a cathode. Fuel cells are used in a wide variety of stationary and mobile applications, for example in houses not connected to the electricity grid or in motor vehicles, rail transport, aviation, space travel, and shipping. In fuel cell units, a large number of fuel cells are arranged in a stack.

In fuel cell units, a large number of fuel cells are arranged in a fuel cell stack. Provided inside each fuel is a gas chamber for oxidizing agents, i.e. a flow chamber for conducting oxidizing agents, such as air from the surroundings comprising oxygen. The gas chamber for oxidizing agents is formed by channels on the bipolar plate and by a gas diffusion layer for a cathode. The channels are thus formed by a corresponding channel structure of a bipolar plate and the oxidizing agent, namely oxygen, reaches the cathode of the fuel cells through the gas diffusion layer. Similarly, a gas chamber for fuel is provided.

Electrolytic cell units consisting of stacked electrolytic cells, similar to fuel cell units, are used for, e.g., the electrolytic production of hydrogen and oxygen from water. Furthermore, fuel cell units are known which can be operated as reversible fuel cell units and thus as electrolytic cell units. Fuel cell units and electrolytic cell units form electrochemical cell units. Fuel cells and electrolysis cells form electrochemical cells.

When manufacturing and assembling electrochemical cells, in particular fuel cells, it is necessary to arrange the components of the fuel cells in an aligned stack. The disc-shaped components of the fuel cells are proton exchange membranes, anodes, cathodes, gas diffusion layers, and bipolar plates. An essential component of the stack are the electrically conductive bipolar plates. The latter function as current collectors for water drainage and for the conduction of the reaction gases and liquid or gaseous coolant through flow spaces, in particular channels or channel structures. The bipolar plates lie upon contact surfaces on the gas diffusion layers.

The bipolar plates are generally formed from two or three stainless steel plates. When manufacturing the bipolar plates, a first and second plate are placed, one upon another, and the plates are then welded together to form weld seams. The weld seams not only have the function of connecting the plates to each other in a bonded and electrically conductive manner, but also serve to fluid-tightly seal channels, which are for coolants and are formed between each two plates. For each bipolar plate, a correspondingly wave-shaped first and second plate are placed, one upon the other, and stacked so that the inner surfaces of the first and second plates lie on one another at strip-shaped contact regions and between the inner surfaces there is a gap having a thickness in each of the strip-shaped contact regions. For a reliable and fluid-tight formation of the weld seam, it is necessary that the thickness of the gaps is small, i.e. the gaps form a technical zero gap less than 20 μm. In addition, the first and second plates are stacked, one upon the other, in a correct lateral relative position as a target position, so that the welded joints are only made at the strip-shaped contact regions acting as joining regions.

If the thicknesses of the gaps are large, the weld seams can no longer be produced without interruptions between the first and second plates, so fluids pass horizontally in the direction of the plane of the first and second plates through leaks between the first and second plates. In order to avoid large gaps at the contact regions, i.e. for the formation of technical zero gaps, contact forces are applied to the first and second plates during the welding process using mechanical hold-down devices, so that as a result of the applied contact forces, the inner surfaces of the first and second plate lie on one another with an additional compressive force at a contact region. Due to the additional compressive force, the zero gap is formed at the contact regions. However, the rod or pincer-shaped mechanical hold-down devices inhibit the formation of the weld seams by means of laser welding because the laser beam is blocked by the mechanical hold-down devices such, that during laser welding, hold-down devices must be constantly released, i.e. deactivated, and others must be placed on the plates, i.e. activated. Therefore, the hold-down devices, e.g. gripping pliers, have to be constantly changed during welding, which is time-consuming.

In addition, it is already known to apply the contact forces from the ambient pressure to the first and second plates with a negative pressure in a negative pressure chamber, so that no constant change of the rod or pincer-shaped hold-down devices is necessary. For example, the negative pressure chamber may be formed by an intermediate space between the first and second plates, or the negative pressure chamber may be delimited by a bottom side of a disk-shaped mechanical hold-down device and a top side of a support plate for the first lower plate. The greater ambient pressure acts on the top side of the mechanical hold-down device and a contact element is formed on the mechanical hold-down device and the contact force is applied to the first and/or second plate with the contact element. The disk-shaped mechanical hold-down device is circular with a circumferential contact projection as a contact element and does not impede guiding the laser beam due to its geometry.

In the bipolar plate, connection channels for fluid-conducting connection of fluid openings are configured as supply and discharge channels for the process fluids of fuel, oxidizing agents and coolants with transverse distribution channels and/or channels for the process fluids. The connection channels open at connection openings into the transverse distribution channels and/or into the channels for the process fluids. For the manufacture of the bipolar plates, the connection openings are mechanically punched into the first and/or second plate using punching machines as a means of providing the first and/or second plate prior to stacking the first and second plate on top of one another and producing the welded joint between the first and second plate. This mechanical forming of the connection openings is disadvantageously expensive with low manufacturing accuracy. In addition, changes to the geometry of the connection openings require costly replacement of the punching tools.

DE 10 2021 206 581 A1 discloses a method for manufacturing a bipolar plate for an electrochemical cell unit, comprising the following steps: providing a first plate and a second plate, stacking the first plate and the second plate, one atop the other, such that inner surfaces of the first and second plate lie, one atop the other, and an intermediate space is formed between the first and second plates; applying contact forces to the first and second plates so that, as a result of the applied contact forces, the inner surfaces of the first and second plates lie, one atop the other with an additional compressive force at a contact region due to the applied contact forces by applying a negative pressure to the intermediate space relative to an ambient pressure, said negative pressure in the intermediate space as a negative pressure chamber causing the contact forces applied to the first and/or second plate to be applied to the first and/or second plate by the ambient pressure.

### SUMMARY

A method according to the invention for manufacturing a bipolar plate for an electrochemical cell unit for converting electrochemical energy into electrical energy as a fuel cell unit and/or for converting electrical energy into electrochemical energy as an electrolytic cell unit having stacked electrochemical cells, the method comprising the steps of: providing a first plate and a second plate, stacking the first plate and the second plate on top of one another such that inner surfaces of the first and second plate lie on top of one another, applying contact forces to the first and second plates by means of negative pressure in a negative pressure chamber relative to an ambient pressure so that, as a result of the contact forces applied by the ambient pressure, the inner surfaces of the first and second plate lie on top of one another with an additional compression force in a contact region due to the applied contact forces, producing at least one welded joint between the first and second plate by means of a laser beam, forming connection channels for process fluids in the first and/or second plate, the channels opening into fluid openings in the bipolar plates and into channels for process fluids in the bipolar plates, forming connection openings in the first and/or second plate which connect the connection channels to the channels for process fluids in the bipolar plates, the connection openings being formed in the first and/or second plate by means of a laser beam. The connection channels are preferably configured between the first and second plate as an intermediate space and/or on an outer side of the first plate and/or on an outer side of the second plate. Preferably, the process fluids are fuel and/or oxidizing agents and/or coolant and/or the electrolyte for the anode and/or the electrolyte for the cathode.

In a further embodiment, the welded joint between the first and second plates is first produced and then the connection openings are formed in the first and/or second plates by means of the laser beam. Preferably, the negative pressure chamber is not applied with a negative pressure during forming of the connection openings by means of the laser beam because the first and second plates are connected to the welded joint during forming of the connection openings. Preferably, the negative pressure chamber is applied with a negative pressure during forming of the connection openings by means of the laser beam.

In a supplementary embodiment, the contact forces are first applied to the first and second plates by means of the negative pressure in the negative pressure chamber relative to the ambient pressure and then simultaneously the welded joint is produced between the first and the second plate.

In an additional variant, the first and/or second plate is formed by means of deforming, in particular embossing, connection channel geometries, such that, after stacking the first plate and the second plate on top of one another, the connection channels are formed as an intermediate space between the first and second plate due to the connection channel geometries. For example, the connection channel geometries are formed with presses as a method step to provide the first and/or second plate.

Preferably, the connection channel geometries in the first and/or second plate are formed prior to stacking the first plate and the second plate on top of one another.

In a further embodiment, the correct position of a focal spot of the laser beam generated by a laser system is optically captured for forming the connection openings on the first and/or second plate, in particular by means of a laser scanner and/or by means of a camera and an image processing system. The laser beam is preferably directed to the optically determined correct position of the focal spot. To determine the optically correct position of the focal spot, the data on the geometry of the first and/or second plate are additionally used.

In a supplementary configuration, the at least one connection opening for each connecting channel is formed by means of the laser beam in the first and/or second plate by cutting the first and/or second plate by means of the laser beam at at least one flap geometry and subsequently moving, in particular pivoting, at least a sub-area of the first and/or second plate as the at least one flap.

The movement of the at least one flap is expediently caused by a residual stress or pretensioning of the first and/or second plate.

In an additional embodiment, the residual stress or pretensioning of the first and/or second plate is introduced into the first and/or second plate with an embossing process, in particular prior to stacking the first and second plate.

In another variant, the at least one connection opening for each connecting channel is formed by means of the laser beam in the first and/or second plate by cutting the first and/or second plate by means of the laser beam at at least one recess geometry and subsequently removing at least a sub-area of the first and/or second plate from the remaining first and/or second plate.

In particular, the at least one connection opening for each connection channel is formed in the first and/or second plate by means of the laser beam by cutting the first and/or second plate by means of the laser beam at at least one remelting geometry and the material of the first and/or second plate melted during cutting is deposited as a melting lip at least partially, preferably at least 90%, 95%, 98% or 99%, in particular completely, on the edge of the first and/or second plate which delimits the at least one connection opening. In the substantially complete attachment or transfer, no deposits, for example as a splash, of the molten material outside the melting lip occur on the remaining bipolar plate.

In an additional configuration, the at least one connection opening is formed slot-shaped and/or circular and/or T-shaped.

Preferably, the laser beam for forming the connection openings has a power of between 200 W and 800W, in particular between 400 W and 600 W and/or the laser beam for forming the connection openings has a diameter of between 100 μm and 500 μm, in particular between 200 μm and 400 μm, and/or a relative speed between the first and/or second plate and the focal spot of the laser beam for forming the connection openings is between 300 mm/sec and 700 mm/sec, in particular between 400 mm/sec and 600 mm/sec, and/or the thickness of the first and/or second plate on the focal spot of the laser beam for forming the connection openings is between 25 μm and 125 μm, in particular between 50 μm and 100 μm.

A method for manufacturing an electrochemical cell unit according to the invention for converting electrochemical energy into electrical energy as a fuel cell unit and/or for converting electrical energy into electrochemical energy as an electrolytic cell unit with stacked electrochemical cells, comprising the following steps: providing layered components of the electrochemical cells, namely preferably proton exchange membranes, anodes, cathodes, gas diffusion layers and bipolar plates, stacking the layered components to form electrochemical cells and to form a stack of the electrochemical cell unit, the bipolar plates being provided by performing a method described in the present patent application.

The electrochemical cell unit according to the present invention for converting electrochemical energy into electrical energy as a fuel cell unit and/or for converting electrical energy into electrochemical energy as an electrolytic cell unit, comprising stacked electrochemical cells and the electrochemical cells each comprise stacked layered components, and the components of the electrochemical cells are preferably proton exchanger membranes, anodes, cathodes, gas diffusion layers and bipolar plates, wherein connection channels for process fluids are formed between the first and second plates in the bipolar plates and the connection channels open in fluid openings and in channels for process fluids in the bipolar plates, and connection channels are configured in the first and/or second plate of the bipolar plates, which connect the connection channels to the channels for process fluids in the bipolar plates, wherein
the electrochemical cell unit is manufactured with a method described in this property right application and/or the connection openings of melting lips are limited in the first and/or second plate, in particular the melting lips have a greater thickness than the first and/or second plate outside the melting lips and/or the melting lips are configured from melted material of the first and/or second plate. Preferably, the thickness of the melting lips is at least 10%, 20%, or 30% greater than the thickness of the first and/or second plate outside of the melting lip at the melting lips or near the melting lips.

In another variant, the connection channels each comprise a first end formed by at least one additional fluid opening, which opens into the fluid opening and a second end formed by at least one connection opening, which opens into the transverse distribution channels and/or into the channels for the process fluids.

In a further variant, an intermediate space between the first and the second plate is configured, in particular on top of one another due to stacking of the first plate and second plate, such that the inner surfaces of the first and second plate lie on top of one another.

In a further embodiment, at least 2, 3, 5, 10 or 10 connection openings are configured on each of the connection channels.

In a further variant, the contact forces with at least one mechanical hold-down device are applied to the first and/or second plate by means of a negative pressure in a negative pressure chamber and by means of an ambient pressure, which indirectly and/or directly act on the at least one mechanical hold-down device. Due to the geometry of the at least one hold-down device, no change of the at least one hold-down device is necessary during the production of the welded joint, because the at least one hold-down device is substantially two-dimensional and/or disk-shaped, such that the extension of the at least one hold-down device towards a fictitious plane subtended by the at least one mechanical hold-down device is significantly greater, in particular at least about the 2, 5, 10, or 20 times greater, as perpendicular to the fictitious plane. Preferably, the at least one mechanical hold-down device and/or a fictitious plane subtended by the at least one mechanical hold-down device during the production of the welded joint and/or forming the connection openings is aligned substantially parallel, in particular with a deviation of less than 30°, 20° or 10°, to the first and/or second plate and/or to a fictitious plane subtended from the first and/or second plate. Preferably, the contact force is substantially constant during the production of the welded joint, preferably with a deviation of less than 30%, 20% or 10%.

In a supplementary embodiment, the negative pressure chamber is delimited by the at least one mechanical hold-down device, such that, due to the negative pressure in the negative pressure chamber and the ambient pressure, a negative pressure force is indirectly and/or directly applied to the holding-down device and this negative pressure from the at least one mechanical holding-down device is at least partially, in particular completely applied, as the at least one contact force is transferred to the first and/or second plate.

In an additional variant, the negative pressure chamber is delimited by a top side of the support plate applied with negative pressure and at least one bottom side of the at least one mechanical hold-down device applied with negative pressure.

In a further embodiment, the intermediate space between the first and second plate as a negative pressure chamber is applied with a negative pressure relative to an ambient pressure such that the contact forces applied to the first and/or second plates are applied to the first and/or second plate by the ambient pressure. Preferably, the disclosure of DE 10 2021 206 581 A1 is incorporated into this property right application.

In an additional embodiment, the negative pressure in the intermediate space is at least 100 mbar, 300 mbar, or 500 mbar less than the ambient pressure. The ambient pressure is generally about 1000 mbar so that a pressure difference between the intermediate space and the surroundings of 700 mbar occurs for a negative pressure of 300 mbar in the intermediate space. The ambient pressure of 1000 mbar thus acts on the outer surfaces of the first and second plates and the negative pressure of 300 mbar acts on the inner surfaces of the first and second plates in the design of the negative pressure chamber as intermediate space so that, due to this pressure difference, the compressive forces on the outer surfaces are greater than on the inner surfaces, so the first and second plate with the additional compressive force lie on one another as the resulting total force without taking gravity into account.

In a supplementary variant, the first plate is first placed on a support plate and then the second plate is placed on the first plate.

Preferably, the intermediate space between the first and second plates is sealed with the at least one sealing means with respect to the surroundings, in particular after the second plate is placed on the first plate.

In a further embodiment, the intermediate space between the first and second plates comprises channels for coolant. Preferably, the intermediate space between the first and second plates comprises technical zero gaps at the contact region.

In a supplementary variant, the welded joint is produced by laser welding.

In an additional embodiment, during the production of the welded joint, in particular continuously, the negative pressure chamber is applied with negative pressure relative to an ambient pressure. Preferably, the negative pressure in the negative pressure chamber is maintained continuously and substantially constantly during the production of the entire welded joint. Preferably, the term “substantially” means having a deviation of less than 30%, 20% or 10%.

In a supplementary embodiment, during the impact of the laser beam on a focal spot on the outer surface of the first plate, an inert gas is conducted to the focal spot, in particular by means of a movable nozzle.

Preferably, the at least one weld seam produced by laser beam welding forms a seal for sealing the at least one channel for coolants outwardly between the first and second plate.

In a further embodiment, at least 90% of the bipolar plates, in particular all bipolar plates, are provided to the fuel cell unit by performing a method described in the present patent application.

In another embodiment, the first and second plates are provided at least partly, in particular completely, made of metal, in particular stainless steel and/or aluminum, and/or plastic and/or composite material.

In another embodiment, the first and second plates are provided at least partly, in particular completely, as wave-shaped and/or disc-shaped and/or in a layered fashion.

In a further embodiment, the bipolar plate is formed from two or three plates, and the two or three plates are connected to each other via the welded joint using the method described in the present patent application.

In another embodiment, the at least one welded connection of the bipolar plate is produced, in particular exclusively, at the contact region.

In another embodiment, the electrochemical cell unit comprises at least 50, 100, 200 or 400 stacked electrochemical cells.

The invention further comprises a computer program having a program code means stored on a computer-readable data carrier for performing a method described in the present patent application when the computer program is executed on a computer or a corresponding computing unit.

The invention further relates to a computer program product comprising program code means stored on a computer-readable data carrier for performing a method described in the present patent application when the computer program is executed on a computer or a corresponding computing unit.

In another variant, the first substance is oxygen and the second substance is hydrogen.

In another variant, the electrolysis cells of the electrolytic cell unit are fuel cells.

In another embodiment, the electrochemical cell unit comprises a housing and/or a connector plate. The stack is enclosed by the housing and/or the connector plate.

In a further embodiment, the fuel cell unit described in the present patent application also forms an electrolytic cell unit acting as a reversible fuel cell unit, and preferably vice versa.

Advantageous components for electrochemical cells, in particular fuel cells and/or electrolytic cells, are preferably insulating layers, in particular proton exchange membranes, anodes, cathodes, preferably gas diffusion layer and bipolar plates, in particular separator plates.

Preferably, the fuel is hydrogen, hydrogen-rich gas, reformate gas, or natural gas.

The fuel cells and/or electrolysis cells are designed to be essentially flat and/or disk-shaped.

In another embodiment, the oxidizing agent is air comprising oxygen or pure oxygen.

Preferably, the fuel cell unit is a PEM fuel cell unit comprising PEM fuel cells or a SOFC fuel cell unit comprising SOFC fuel cells or an alkaline fuel cell (AFC).

### BRIEF DESCRIPTION OF THE DRAWINGS

In the following, exemplary embodiments of the invention are described in more detail with reference to the accompanying drawings. Shown are:

FIG. 1 a highly simplified exploded view of an electrochemical cell system as a fuel cell system and electrolysis cell system comprising components of an electrochemical cell as a fuel cell and electrolysis cell,

FIG. 2 a perspective view of part of a fuel cell and electrolysis cell,

FIG. 3 a longitudinal section through electrochemical cells as fuel cells and electrolytic cells,

FIG. 4 a perspective view of an electrochemical cell unit as a fuel cell unit and electrolytic cell unit as a fuel cell stack and electrolytic cell stack,

FIG. 5 a side view of the electrochemical cell unit as a fuel cell unit and electrolytic cell unit as a fuel cell stack and electrolytic cell stack,

FIG. 6 a perspective view of a bipolar plate,

FIG. 7 an enlarged longitudinal section through a fuel cell and electrolytic cell in the region of a weld seam,

FIG. 8 a longitudinal section through a bipolar plate comprising two plates which are joined to one another using a weld seam in the form of a through-weld, and a welded-in joint is also formed,

FIG. 9 a longitudinal section through a bipolar plate comprising two plates which are joined to one another using a weld seam in the form of a weld-in during the welding process using a laser beam,

FIG. 10 a longitudinal section through the two plates when laid upon a support plate during the welding operation,

FIG. 11 a horizontal cut through the bipolar plate in the area of a fluid opening as a removal channel for oxidizing agents,

FIG. 12 an enlarged detail of FIG. 11,

FIG. 13 a vertical cross-section through the bipolar plate in the area of connection channels,

FIG. 14 a vertical longitudinal section through the bipolar plate in the area of a connection channel,

FIG. 15 a perspective partial view of the bipolar plate at connection openings for passing process fluids into or out of the connection channel in a first exemplary embodiment,

FIG. 16 a section A-A according to FIG. 15 of a second plate of the bipolar plate with the connection openings,

FIG. 17 a perspective partial view of the bipolar plate at connection openings for passing process fluids into or out of the connection channel in a second exemplary embodiment,

FIG. 18 a perspective partial view of the bipolar plate at connection openings for passing process fluids into or out of the connection channel in a third exemplary embodiment,

FIG. 19 a section B-B according to FIG. 18 of a second plate of the bipolar plate with the connection openings,

FIG. 20 a perspective partial view of the bipolar plate at connection openings for passing process fluids into or out of the connection channel in a fourth exemplary embodiment, and

FIG. 21 a perspective partial view of the bipolar plate at connection openings for passing process fluids into or out of the connection channel in a fifth exemplary embodiment.

### DETAILED DESCRIPTION

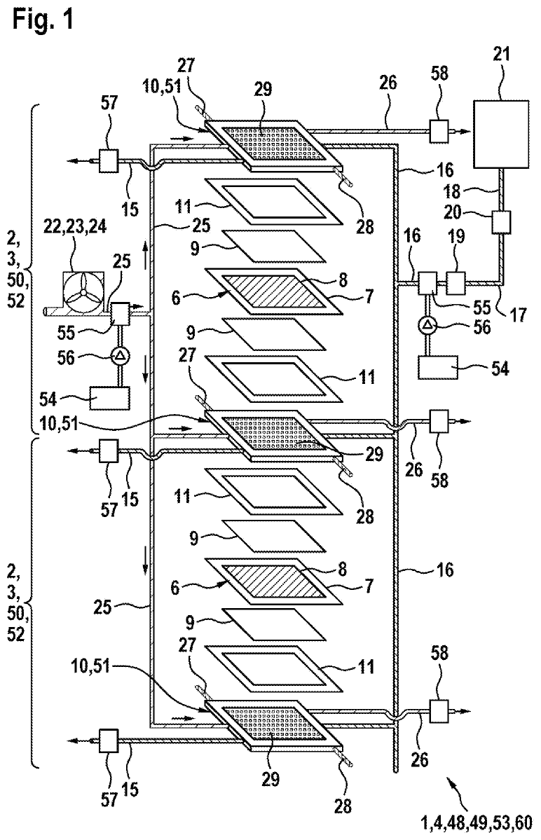

In FIGS. 1 to 3, the basic construction of a fuel cell 2 is shown as a PEM fuel cell 3 (polymer electrolyte fuel cell 3). The principle of fuel cells 2 is that electrical energy or electrical current is generated by means of an electrochemical reaction. Hydrogen H₂ is conducted to an anode 7 as a gaseous fuel, and the anode 7 forms the negative pole. A gaseous oxidant, i.e., air with oxygen, is conducted to a cathode 8, i.e., the oxygen in the air provides the necessary gaseous oxidant. A reduction (electron uptake) takes place on the cathode 8. The oxidation as electron output is performed at the anode 7.

The redox equations of the electrochemical processes are as follows:

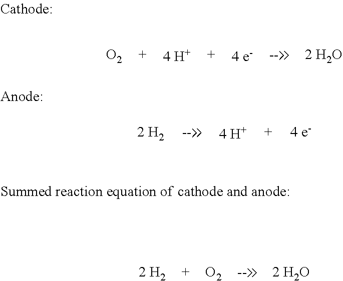

The difference in the normal potentials of the electrode pairs under standard conditions as reversible fuel cell voltage or neutral voltage of the unloaded fuel cell 2 is 1.23 V. This theoretical voltage of 1.23 V is not achieved in practice. At rest and at small currents, voltages above 1.0 V can be achieved and, in operation at larger currents, voltages between 0.5 V and 1.0 V are achieved. The series connection of multiple fuel cells 2, in particular a fuel cell unit 1 as a fuel cell stack 1 of multiple stacked fuel cells 2, has a higher voltage, which corresponds to the number of fuel cells 2 multiplied by the individual voltage of each fuel cell 2.

The fuel cell 2 also comprises a proton exchange membrane 5 (PEM), which is arranged between the anode 7 and the cathode 8. The anode 7 and cathode 8 are designed in a layer or disc shape. The PEM 5 functions as an electrolyte, catalyst carrier, and separating device for the reaction gases. The PEM 5 also functions as an electrical insulator and prevents an electrical short circuit between the anode 7 and cathode 8. In general, 12 μm to 150 μm thick, proton-conductive films made of perfluorinated and sulfonated polymers are used. The PEM 5 conducts the protons H⁺ and substantially blocks ions other than protons H⁺ so that charge transport can occur due to the permeability of PEM 5 for the protons H⁺. The PEM 5 is substantially impermeable to the reaction gases oxygen O₂ and hydrogen H₂, i.e. it blocks the flow of oxygen O₂ and hydrogen H₂ between a gas chamber 31 at the anode 7 with hydrogen fuel H₂ and the gas chamber 32 at the cathode 8 with air or oxygen O₂ as oxidizing agents. The proton conductivity of the PEM 5 increases with increasing temperature and increasing water content.

On the two sides of the PEM 5, each facing the gas chambers 31, 32, the electrodes 7, 8 are located as the anode 7 and cathode 8. A unit consisting of the PEM 5 and the electrodes 7, 8 is referred to as a membrane electrode arrangement 6 (MEA). The electrodes 7, 8 are pressed together using the PEM 5. The electrodes 7, 8 are platinum-containing carbon particles bonded to PTFE (polytetrafluorethylene), FEP (fluorinated ethylene-propylene copolymer), PFA (perfluoroalkoxy), PVDF (polyvinylidene fluoride), and/or PVA (polyvinyl alcohol) and hot-pressed in microporous carbon fiber, glass fiber, or plastic mats. A catalyst layer 30 is normally applied to each of the electrodes 7, 8 on the side facing the gas chambers 31, 32 (not shown). The catalyst layer 30 at the gas chamber 31 with fuel at the anode 7 comprises nanodispersed platinum-ruthenium on graphitized carbon black particles bonded to a binder. The catalyst layer 30 on the gas chamber 32 having oxidizing agent on the cathode 8 similarly comprises nanodispersed platinum. For example, binders include Nafion®, a PTFE emulsion, or polyvinyl alcohol.

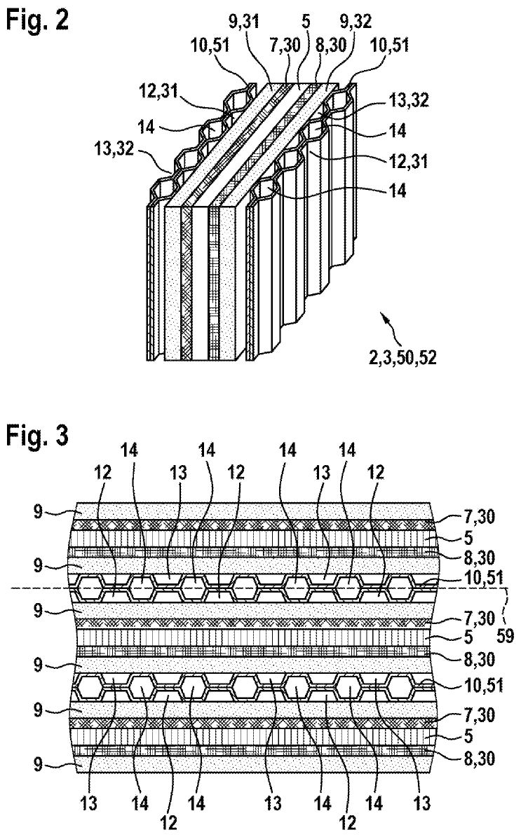

In contrast, the electrodes 7, 8 are composed of an ionomer, e.g. Nafion®, platinum-containing carbon particles and additives. These electrodes 7, 8 comprising the ionomer are electrically conductive due to the carbon particles and also conduct the protons H⁺ and also act as a catalyst layer 30 (FIGS. 2 and 3) due to the platinum-containing carbon particles. Membrane electrode arrangements 6 having these electrodes 7, 8 and comprising the ionomer form membrane electrode arrangements 6 as CCM (catalyst coated membrane).

A gas diffusion layer 9 (GDL) is located on the anode 7 and cathode 8. The gas diffusion layer 9 at the anode 7 evenly distributes the fuel from channels 12 for fuel to the catalyst layer 30 at the anode 7. The gas diffusion layer 9 on the cathode 8 evenly distributes the oxidizing agent from channels 13 for oxidizing agent onto the catalyst layer 30 at the cathode 8. The GDL 9 also draws reaction water counter to the direction of flow of the reaction gases, i.e. in a direction from the catalyst layer 30 or electrodes 7, 8 to the channels 12, 13. Furthermore, the GDL 9 keeps the PEM 5 moist and conducts the power. The GDL 9, for example, is composed of a hydrophobized carbon paper as a carrier and substrate layer and a bonded carbon powder layer as a microporous layer.

A bipolar plate 10 lies atop the GDL 9. The electrically conductive bipolar plate 10 serves as a current collector, for draining water and for conducting the reaction gases as process fluids through the channel structures 29 and/or flow fields 29 and for dissipating the waste heat, which occurs in particular during the exothermic electrochemical reaction at the cathode 8. To dissipate waste heat, channels 14 are incorporated into the bipolar plate 10 as a channel structure 29 for conducting a liquid or gaseous coolant through as a process fluid. The channel structure 29 on the gas chamber 31 for fuel is formed by channels 12. The channel structure 29 on the gas chamber 32 for oxidizing agents is formed by channels 13. For example, metal, conductive plastics, and composites and/or graphite are used as the material for the bipolar plates 10.

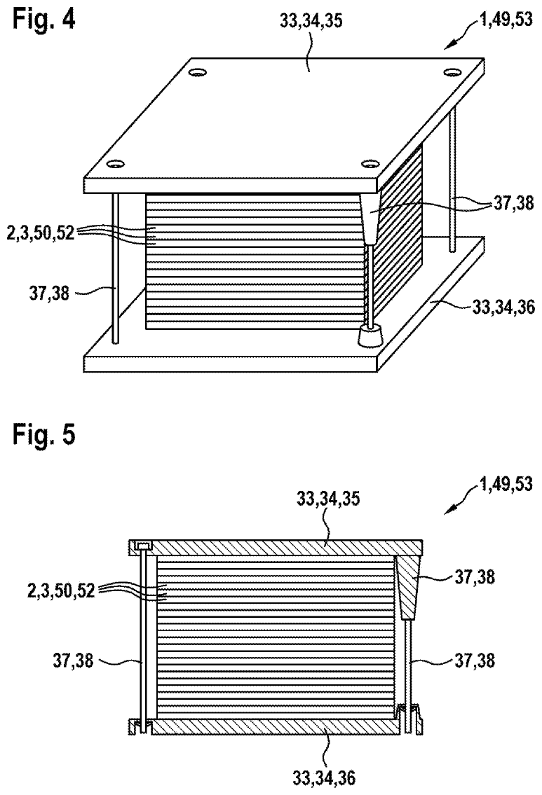

In a fuel cell unit 1 and/or a fuel cell stack 1 and/or a fuel cell stack 1, multiple fuel cells 2 are arranged so to as to be stacked in alignment (FIGS. 4 and 5). FIG. 1 shows an exploded view of two fuel cells 2 arranged in an aligned stack. Sealing gaskets 11 seal the gas chambers 31, 32 or channels 12, 13 in a fluid-tight manner. In a compressed gas reservoir 21 (FIG. 1), hydrogen H₂ is stored as a fuel at a pressure of, e.g., 350 bar to 700 bar. From the compressed gas reservoir 21, the fuel is conducted through a high pressure line 18 to a pressure reducer 20 in order to reduce the pressure of the fuel in a medium pressure line 17 of about 10 bar to 20 bar. From the medium pressure line 17, the fuel is conducted towards an injector 19. At the injector 19, the pressure of the fuel is reduced to an injection pressure of between 1 bar and 3 bar. From the injector 19, the fuel is supplied to a fuel supply line 16 (FIG. 1) and from the supply line 16 to the fuel channels 12 forming the channel structure 29 for fuel. As a result, the fuel flows through the gas chamber 31 for the fuel. The gas chamber 31 for the fuel is formed by the channels 12 and the GDL 9 at the anode 7. After flowing through the channels 12, the fuel not consumed in the redox reaction at the anode 7 (and optionally water from a controlled humidification means of the anode 7) is conducted out of the fuel cells 2 via a discharge line 15.

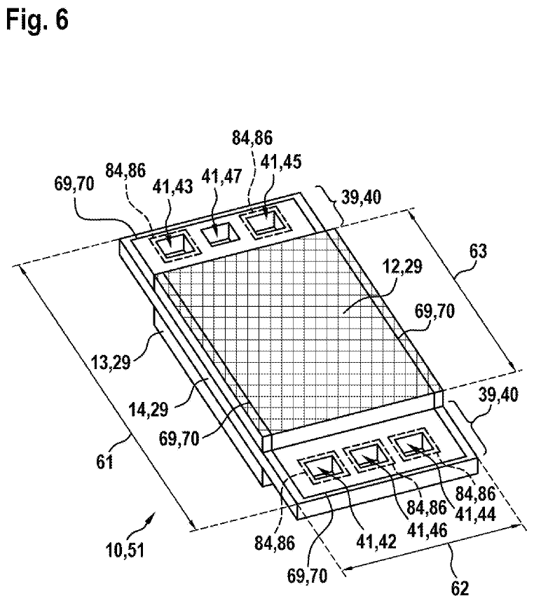

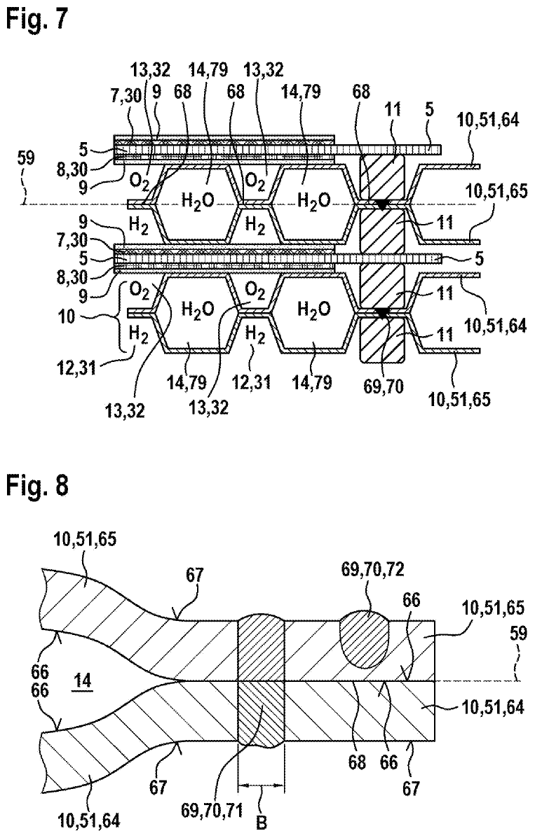

A gas conveying device 22, designed as, e.g., a blower 23 or a compressor 24 or a turbo compressor, conveys air from the surroundings as an oxidizing agent into an oxidizing agent supply line 25. From the supply line 25, the air is supplied to the oxidizing agent channels 13, which form a channel structure 29 on the bipolar plates 10 for oxidizing agents such that the oxidizing agent flows through the gas chamber 32 for the oxidizing agent. The gas chamber 32 for the oxidizing agent is formed by the channels 13 and the GDL 9 on the cathode 8. After flowing through the channels 13 or the gas chamber 32 for the oxidizing agent 32, the oxidizing agent not consumed on the cathode 8 and the reaction water resulting on the cathode 8 due to the electrochemical redox reaction are conducted out of the fuel cells 2 through a discharge line 26. A supply line 27 is used to supply coolant into the channels 14 for coolant, and a discharge line 28 is used to discharge coolant conducted through the channels 14. The supply and discharge lines 15, 16, 25, 26, 27, 28 are shown as separate lines in FIG. 1 for reasons of simplification. Formed the end region in the vicinity of the channels 12, 13, 14 are fluid openings 41 in the stack of the fuel cell unit 1 on sealing plates 39 as an extension at the end region 40 of the bipolar plates 10 (FIG. 6) and membrane electrode arrangements 6 (not shown) lying one atop the other. The fuel cells 2 and the components of the fuel cells 2 are disk-shaped and span imaginary planes 59 that are essentially parallel to one another. The fluid openings 41 and seals (not shown) that are flush in a direction perpendicular to the imaginary planes 59 between the fluid openings 41 therefore form a supply channel 42 for an oxidizing agent, a discharge channel 43 for an oxidizing agent, a supply channel 44 for fuel, a discharge channel 45 for fuel, a supply channel 46 for coolant, and a discharge channel 47 for coolant. The supply and discharge lines 15, 16, 25, 26, 27, 28 outside the stack of the fuel cell unit 1 are designed as process fluid lines. The supply and discharge lines 15, 16, 25, 26, 27, 28 outside the stack of the fuel cell unit 1 open into the supply and discharge channels 42, 43, 44, 45, 46, 47 inside the stack of the fuel cell unit 1. The fuel cell stack 1, together with the compressed gas reservoir 21 and the gas conveying device 22, form a fuel cell system 4.

In the fuel cell unit 1, the fuel cells 2 are arranged between two clamping elements 33 as clamping plates 34. A first clamping plate 35 rests on the first fuel cell 2 and a second clamping plate 36 rests on the last fuel cell 2. The fuel cell unit 1 comprises approximately 200 to 400 fuel cells 2, not all of which are shown in FIGS. 4 and 5 for graphic reasons. The clamping elements 33 apply a compressive force to the fuel cells 2, i.e., the first clamping plate 35 rests with a compressive force on the first fuel cell 2, and the second clamping plate 36 rests with a compressive force on the last fuel cell 2. The fuel cell stack 2 is thus braced to ensure tightness for the fuel, the oxidizing agent and the coolant, in particular due to the elastic sealing gaskets 11, and also to keep the electrical contact resistance within the fuel cell stack 1 as low as possible. To clamp the fuel cells 2 using the clamping elements 33, four connection devices 37 are designed on the fuel cell unit 1 as bolts 38, which are tensioned. The four bolts 38 are connected to the clamping plates 34.

FIG. 6 shows the bipolar plate 10 of the fuel cell 2. The bipolar plate 10 comprises the channels 12, 13 and 14 as three separate channel structures 29. The channels 12, 13 and 14 are not shown separately in FIG. 6, but merely simplified as a layer of a channel structure 29. The fluid openings 41 on the sealing plates 39 of the bipolar plates 10 and membrane electrode arrangements 6 (not shown) are stacked in alignment within the fuel cell unit 1, so that supply and discharge channels 42, 43, 44, 45, 46, 47 are formed. Sealing gaskets (not shown) are in this case arranged between the sealing plates 39 for the fluid-tight sealing of the supply and discharge channels 42, 43, 44, 45, 46, 47 formed by the fluid openings 41. The bipolar plate 10 has a length 61 and a width 62. The channel 14 or channels 14 for coolant as a channel structure 29 have a length 63, and the width of the channel structure 29 substantially corresponds, in particular with a deviation of less than 20% or 10%, to the width 62 of the bipolar plate 10.

Since the bipolar plate 10 also separates the gas chamber 31 for fuel from the gas chamber 32 for oxidizing agent in a fluid-tight manner and also seals the channel 14 for coolant in a fluid-tight manner, the term separator plate 51 can also be selected for the bipolar plate 10 for the fluid-tight decomposition or separation of process fluids. In this context, the term “bipolar plate” 10 also includes the term “separator plate” 51, and vice versa. The channels 12 for the fuel, the channels 13 for the oxidizing agent, and the channels 14 for the coolant of the fuel cell 2 are also formed on the electrochemical cell 52, but with different functions.

The fuel cell unit 1 can also be used and operated as an electrolytic cell unit 49, i.e. it forms a reversible fuel cell unit 1. In the following, some features are described which enable the fuel cell unit 1 to be operated as an electrolytic cell unit 49. A liquid electrolyte, namely highly diluted sulfuric acid at a concentration of approximately c (H₂SO₄)=1 mol/L, is used for electrolysis. A sufficient concentration of oxonium ions H₃0⁺ in the liquid electrolyte is necessary for electrolysis.

The following redox reactions take place during electrolysis:

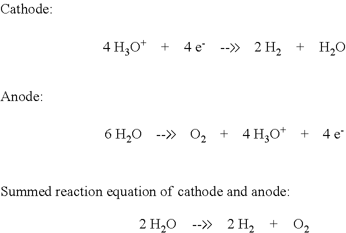

The polarity of the electrodes 7, 8 is reversed using electrolysis during operation as an electrolytic cell unit 49 (not shown) as during operation as a fuel cell unit 1, so that hydrogen H₂ is formed as a second substance at the cathodes in the channels 12 for fuel, through which the liquid electrolyte is conducted, and the hydrogen H2 is absorbed by the liquid electrolyte and transported in solution. Similarly, the liquid electrolyte is conducted through the channels 13 for oxidizing agents, and oxygen O₂ is formed as the first substance at the anodes in or at channels 13 for oxidizing agents. The fuel cells 2 of the fuel cell unit 1 function as electrolysis cells 50 during operation as electrolytic cell unit 49. The fuel cells 2 and electrolysis cells 50 thus form electrochemical cells 52. The oxygen O₂ formed is absorbed by the liquid electrolyte and transported in solution. The liquid electrolyte is stored in a storage reservoir 54. For reasons of simplification, FIG. 1 shows two storage reservoirs 54 of the fuel cell system 4, which also functions as an electrolysis cell system 48. The three-way valve 55 on the supply line 16 for fuel is switched over during operation as an electrolytic cell unit 49 so that, instead of fuel from the compressed gas reservoir 21, the liquid electrolyte is conducted into the supply line 16 for fuel using a pump 56 from the storage reservoir 54. A three-way valve 55 on the supply line 25 for oxidizing agent is switched over during operation as electrolytic cell unit 49 so that, instead of oxidizing agent as air from the gas conveying device 22, the liquid electrolyte is conducted into the supply line 25 for oxidizing agent using the pump 56 from the storage reservoir 54. The fuel cell unit 1, which also functions as an electrolytic cell unit 49, features optional modifications to the electrodes 7, 8 and the gas diffusion layer 9 compared to a fuel cell unit 1 that can only be operated as a fuel cell unit 1. For example, the gas diffusion layer 9 is not absorbent, so that the liquid electrolyte easily runs off completely, or the gas diffusion layer 9 is not formed, or the gas diffusion layer 9 is a structure on the bipolar plate 10. The electrolytic cell unit 49 comprising the storage reservoir 54, the pump 56, the separators 57, 58, and preferably the three-way valve 55 forms an electrochemical cell system 60.

A separator 57 for hydrogen is arranged on the discharge line 15 for fuel. The separator 57 separates the hydrogen from the electrolyte comprising hydrogen, and the separated hydrogen is conducted into the compressed gas reservoir 21 by means of a compressor (not shown). The electrolyte conducted out of the separator 57 for hydrogen is then fed back into the storage reservoir 54 for the electrolyte via a line. A separator 58 for oxygen is arranged on the discharge line 26 for fuel. The separator 58 separates the oxygen from the electrolyte comprising oxygen, and the separated oxygen is fed into a compressed gas reservoir for oxygen (not shown) using a compressor (not shown). The oxygen in the compressed gas reservoir for oxygen (not shown) can optionally be used for operating the fuel cell unit 1 by conducting the oxygen into the supply line 25 for oxidizing agent using a line (not shown) during operation as a fuel cell unit 1. The electrolyte conducted out of the separator 58 for oxygen is then fed back into the storage reservoir 54 for the electrolyte via a line. The channels 12, 13 and the discharge and supply lines 15, 16, 25, 26 are designed such that, after use as an electrolytic cell unit 49 and the pump 56 has been switched off, the liquid electrolyte runs back completely into the storage reservoir 54 due to gravity. Optionally, after use as an electrolytic cell unit 49 and before use as a fuel cell unit 1, an inert gas is conducted through the channels 12, 13 and the discharge and supply lines 15, 16, 25, 26 to completely remove the liquid electrolyte before the gaseous fuel and oxidizing agent are conducted through. The fuel cells 2 and the electrolysis cells 2 thus form electrochemical cells 52. The fuel cell unit 1 and the electrolytic cell unit 49 thus form an electrochemical cell unit 53. The channels 12 for fuel and the channels for oxidizing agent thus form channels 12, 13 for conducting the liquid electrolyte through during operation as an electrolytic cell unit 49, and this applies in a similar manner to the supply and discharge lines 15, 16, 25, 26. For process-related reasons, an electrolytic cell unit 49 does not normally require channels 14 for the conduction of coolant. In an electrochemical cell unit 49, the channels 12 for fuel also form channels 12 for conducting fuel and/or electrolytes through, and the channels 13 for oxidizing agents also form channels 13 for guiding fuel and/or electrolytes.

The bipolar plates 10 are produced from the first plate 64 and the second plate 65 as monopolar plates 64, 65 using laser steel welding. For this purpose, for each bipolar plate 10, a correspondingly wave-shaped first and second plate 64, 65 is placed on top of one another and stacked so that the inner surfaces 66 of the first and second plates 64, 65 lie on top of one another at strip-shaped contact regions 68 as a butt joint. The imaginary planes 59 subtended by the disc-shaped first and second plates 64, 65 are subsequently aligned substantially parallel to each other. The first and second stainless steel plates 64, 65 each comprise an outer surface 67 opposite to the inner surfaces 66. After arranging the two plates 64, 65 as output plates 64, 65 for the manufacture of the bipolar plates 10, strip-shaped coolant channels 14 for coolant are formed outside the strip-shaped contact regions 68 between the inner surfaces 66 of the first and second plates 64, 65, which form an intermediate space 79. The geometry of the first and second plates 64, 65 provided with a large number of waves causes a large number of channels 14 to be formed between the contact regions 68.

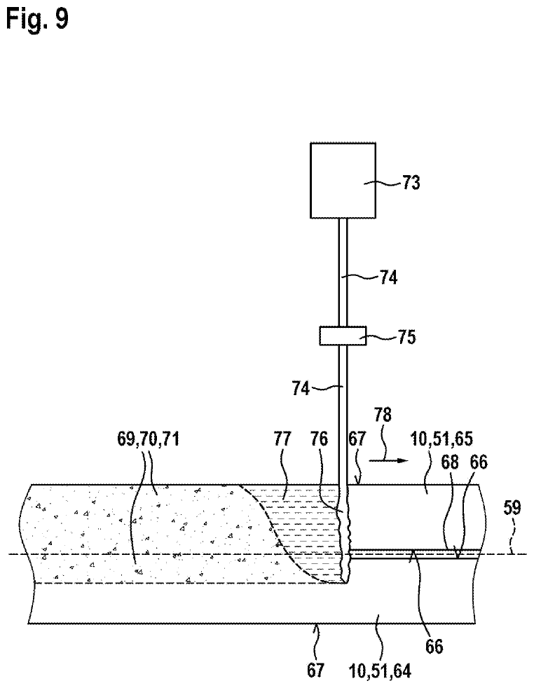

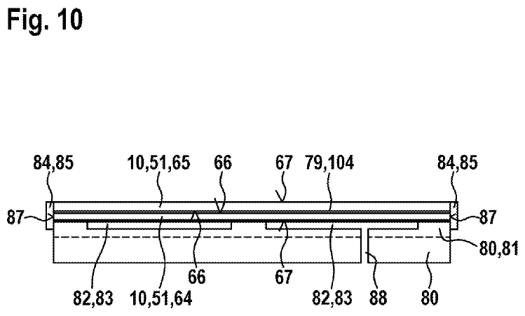

The first and second plates 64, 65 as monopolar plates 64, 65 are joined together in a material-locking manner by laser beam welding to form the bipolar plate 10 such that a welded joint 69 is produced as a large number of weld seams 70 between the first and second plates 64, 65. A laser system includes a laser 73 that emits a laser beam 74 (FIG. 9). The laser 73 emits a laser beam 74 as a bundled electromagnetic wave. The laser beam 74 is emitted onto the outer surface 67 of the second plate 65 by an optical system 75 such that the laser beam 74 impinges on the outer surface 67 of the second plate 65 at a focal spot having a diameter of about 100 μm. A motion unit (not shown) moves either the laser beam 74 over the outer surface 67 of the second plate 65 and/or the first and second plates 64, 65 below the laser beam 74 such that a relative feed direction 78 of the laser beam 74 to the first and second plates 64, 65 is achieved. The laser beam 74 is absorbed by the outer surface 67 of the second plate 65 such that during the welding process the temperature of the stainless steel of the first and second plate 64, 65 rises above the melting temperature, thereby forming a liquid melt 77 during the welding process, which subsequently cools down again and solidifies to form the welded joint 69 as the weld seam 70. Furthermore, a keyhole 76 optionally forms as a vapor capillary in the liquid melt 76 in the beam direction of the laser beam 74, which is formed as a tubular cavity of metal vapor and/or partially ionized metal vapor, respectively, in each case below the laser beam 74, which is moved relative to the first and second plates 64, 65 in the feed direction 78. Depending on the depth of the optional keyhole 76 and the liquid melt 77, a through-weld 71 or a weld-in 72 (FIG. 8) of the welded joint 70 is formed. The width B (FIG. 8) of the weld seam 70 substantially corresponds to the diameter of the laser beam 74 or focal spot.

The weld seam 70 is configured fully continuous and fluid-tight at edge areas near the longitudinal and broad sides of bipolar plate 10 for sealing the intermediate space 79 with coolant so that coolant cannot flow outwardly. In the bipolar plate 10, transverse distribution channels 94 between the first and second plate 64, 65 for directing the coolant from the supply channel 46 into the channel structure 29 and from the channel structure 29 into the discharge channel 47 for coolant are formed. This weld seam 70 thus also acts as a seal for sealing the channels 14 for coolant to the outside of the channels 14. In FIG. 6, the weld seams 70 shown as a seal for the coolant outwardly are greatly simplified as a continuous straight line. Optionally, further weld seams 70 formed in sections may be produced at the contact regions 68 that do not have a sealing function for the coolant in the surroundings or to the outside and only serve to provide a material-locking connection of the two plates 64, 65 and optionally also function as a seal between two channels 14 for coolant.

To manufacture the bipolar plate 10, the first plate 64 and the second plate 65 are first made of stainless steel. The first and second plates 64, 65 have a thickness of approximately 70 μm. A horizontal and planar support plate 80 made of steel has an elastic sealing layer 81 made of rubber at the top side. A plurality of recesses are formed in this elastic sealing layer 81, which form negative pressure part chambers 83 after the first plate 64 has been placed on the elastic sealing layer 81. After the first plate 64 has been placed on the elastic sealing layer 81 of the support plate 80, a negative pressure is generated in the negative pressure chambers 83 by a negative pressure pump (not shown). A suction channel 88 is formed in the support plate 80 for this purpose. The suction channel 88 is fluidly connected to all negative pressure part chambers 83 and the negative pressure part chambers 83 in total form a negative pressure chamber 82. The negative pressure in the negative pressure chamber 82 on the one hand between the outer surface 67 of the first plate 64 and the top of the support plate 80 is low and is in the ranges of about 800 mbar, i.e. the difference between the negative pressure vacuum and the ambient pressure is about 200 mbar. Due to this negative pressure in the negative pressure chamber 82, the first plate 64 with a process additional compressive force rests on the top side of the support plate 80. The outer surface 67 of the first plate 64 therefore adjoins the support plate 80 with a compressive force formed from the sum of the process additional compressive force and the gravitational force of the first plate 64. As a result, a reliable interlocking and/or frictional connection between the lower outer surface 67 of the first plate 64 and the top of the support plate 80 such that the first plate 64 is thereby positioned precisely relative to the support plate 80 without displacement and thus the weld seams 70 can be accurately produced at the correct positions.

The second plate 65 is then placed in the exact position on the first plate 64. Subsequently, a sealing means 84, namely a multi-part sealing frame 85 with an inner rubber sealing ring and an outer metal frame (not shown), is arranged on the outer edge 87 of the two plates 64,65 lying on top of one another. Furthermore, all fluid openings 41, other than the discharge channel 47 of the coolant, are sealed with a process seal 86 as a further sealing means 84. The process seals 86 are shown dashed in FIG. 6. A large vacuum is then generated at the discharge channel 47 for coolant, which is formed by two aligned fluid openings 41 of the first and second plates 64, 65 on the sealing plate 39 using a vacuum pump (not shown). For this purpose, the vacuum pump is connected to a vacuum hose (not shown) and the vacuum hose is brought into fluid-conductive connection with the underside as the outer surface 67 of the first plate 64. The outer surface 67 as the top side of the second plate 65 is fluid-tightly sealed with a sealing means. Since the outer edge 87 and the remaining fluid openings 41 are sealed, a strong negative pressure of about 400 mbar is thus generated in the intermediate space 79 and is formed substantially by the channels 14 for coolant. The pressure difference between the ambient pressure and the negative pressure in the intermediate space 79 formed as a negative pressure chamber 104 is thus approximately 600 mbar. The ambient pressure of the air thus applies a substantially constant contact force to on the outside surface 67 of the second plate 65. This contact force is substantially constant per unit area, so that the outer surface 67 of the second plate 65 is advantageously subjected to a constant pressure. The negative pressure in the negative pressure chamber 82 is smaller than in the intermediate space 79, so that a smaller contact force per unit area acts on the lower outer surface 67 of the first plate 64 than on the upper outer surface 67 of the second plate 65, and the difference therefrom is applied as a compressive force from the first plate 64 to the support plate 80 without taking gravity into account. The contact forces are thus compressive forces. At the contact region 68, the inner surfaces 66 of the first and second plates 64, 65 thus lie on top of one another with additional compressive forces and, due to the size of these additional compressive forces, a technical zero gap of less than 20 μm substantially occurs at the contact regions 68. The weld seams 70 are then produced using the laser 73.

Optionally, before the negative pressure is generated in the intermediate space 79 as a negative pressure chamber 104, the intermediate space 79 is flooded with an inert gas, in particular nitrogen or a noble gas, and preferably the inert gas is also constantly conducted through the intermediate space 79 during the generation and maintenance of the negative pressure. This is achieved by, e.g., additionally conducting a small amount of inert gas into and through the supply channel 46 during suction using the vacuum pump at the discharge channel 47 for coolant. Given that it is not technically possible to seal the outer edge 87 and the remaining fluid openings 41 in a completely sealed manner, it is necessary to constantly introduce inert gas into the intermediate space 79 while maintaining the negative pressure, so that inert gas is constantly present in the intermediate space 79 during welding. Moreover, inert gas is constantly supplied to the outside of the focal spot on the outer surface 67 of the second plate 65, i.e., the point of impact of the laser beam 74. As a result, the weld seam 70 can be produced completely with inert gas flushing.

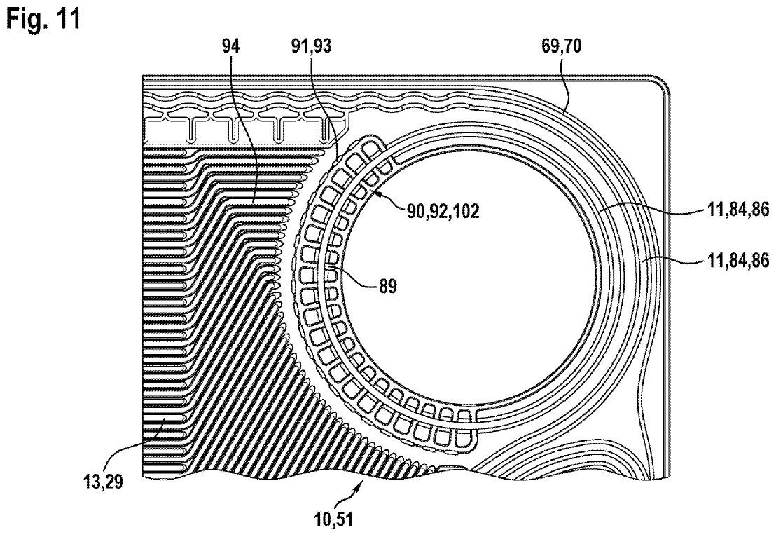

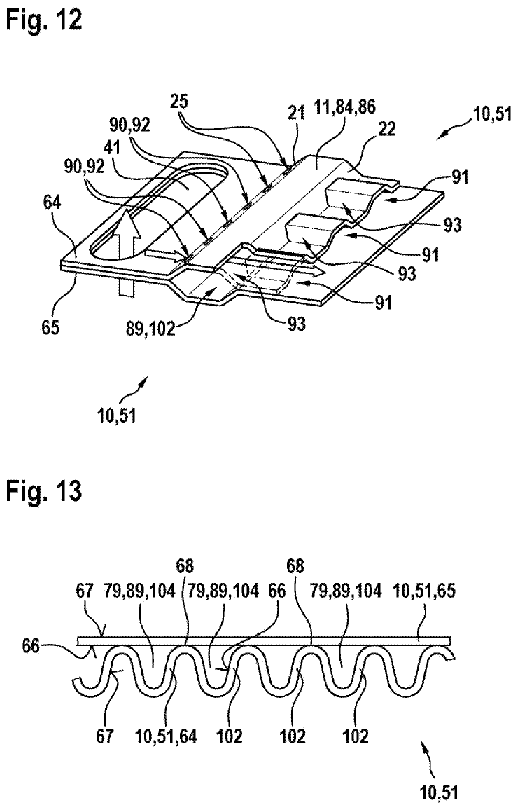

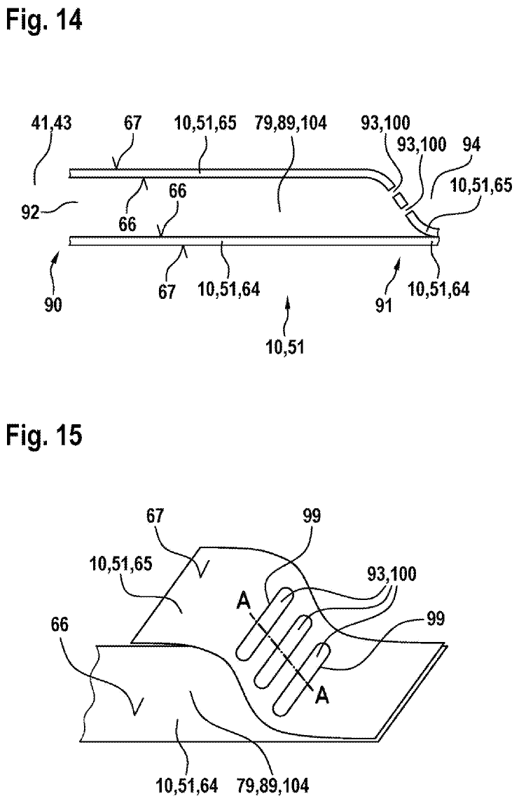

In the area of the fluid openings 41, weld seams 70 (shown only in FIGS. 11 and 12) are produced circumferentially by means of laser welding in the fluid openings 41, in order to avoid uncontrolled influx of the process fluids into the intermediate space 79 between the first and second plates 64, 65. The process fluids are introduced into or discharged from the fluid openings 41 using connection channels 89 in the fluid openings 41. However, the weld seams 70 at the fluid openings 41 are not formed at the connection channels 89. For example, FIG. 11 shows the discharge channel 43 for oxidizing agents. The oxidizing agent is directed through the channels 13 on an outer side 67 of the first plate 64 in the area of the membrane electrode assembly 5. After flowing through the channels 13, the oxidizing agent flows into transverse distribution channels 94 on the outer side 67 and is directed from the transverse distribution channels 94 to the connection channels 89 on the discharge channel 43. The connection channels 89 (FIGS. 11-14) are formed between the first and second plates 64, 65. For this purpose, an undulating connection channel geometry 102 with reshaping, for example embossing, has been formed into the first plate 64 prior to stacking the second plate 65 on the first plate 64 and prior to the production of the welded joint 70. The connection channels 89 have a first end 90 which opens into the fluid opening 41 and a second end 91 which directly opens into the transverse distribution channels 89 and indirectly into the channels 12, 13 and 14 for the process fluids. The connection channels 89 open into the fluid openings 41 at the additional fluid port 92 as the first end 90. The connection channels 89 open at the connection opening 93 as the second end 91 directly into the transverse distribution channels 89 and indirectly into the channels 12, 13 and 14 for the process fluids. A plurality of connection openings 93 can also be formed on each connection channel 89. In the discharge channel 43 shown in FIG. 11, the oxidizing agent flows from the transverse distribution channels 94 through the connection openings 93 into the connection channels 89 and from the connection channels 89 through the additional fluid openings 92 into the discharge channel 43 as the fluid opening 41. In the fluid opening 41 as the supply channel 42 for oxidizing agent, the oxidizing agent flows in the reverse direction through the connection channels 89, i.e., flows from the supply channel 42 through the additional fluid openings 92 into the connection channels 89 and from the connection channels 89 through the connection openings 93 directly into the transverse distribution channels 94 and indirectly into the channels 13 for the oxidizing agent. The channels 13 for oxidizing agents and the transverse distribution channels 94 for oxidizing agents are formed on the outer sides 67 of the first plate 64.

The routing of the fuel process fluid through the fluid openings 41 as a supply channel 44 and the discharge passage 45 for fuel through the connection channels 89, the transverse distribution channels 94 and the channels 12 for fuel are performed analogously to the oxidizing agent process fluid. The transverse distribution channels 94 and the channels 12 for fuel are formed on the outer side 67 of the second plate 65.

The routing of the coolant process fluid through the fluid openings 41 as a supply channel 46 and the discharge channel 47 for coolant through the connection channels 89, the transverse distribution channels 94 and channels 14 for coolant is performed analogously to the oxidizing agent process fluid, but the transverse distribution channels 94 and channels 14 for coolant are limited by the inner sides 66 of the first and second plates 64,65 i.e., are formed between the first and second plates 64, 65.

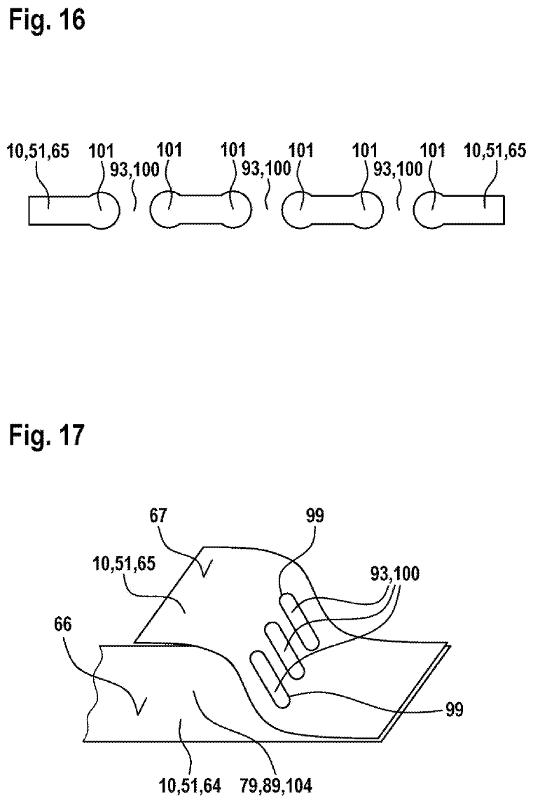

In FIGS. 15 and 16, a first exemplary embodiment of the configuration of the connection openings 93 is shown as slot-shaped connection openings 100. The connection openings 93 are formed by means of the laser beam 74 from the laser 73 into the second plate 65. This forming of the connection openings 93 is performed after the production of the welded joint 69 with the weld seams 70, in particular after the production of all the weld seams 70, between the first and second plates 64, 65, and thus also after the contact forces have been applied between the first and second plates 64, 65 by means of negative pressure in the negative pressure chamber 104 as the intermediate space 79. The laser beam 74 melts and cuts the second plate 65 at a remelting geometry 99 and this is guided to form the slot-shaped connection openings 100. The material of the second plate 65 melted at the slot-shaped connection openings 100 is completely delimited around and melted at the edge or boundary area of the second plate 65, which limits the slot-shaped connection openings 100 as the connection openings 93, such that a melting lip 101 (FIG. 16) with a substantially circular or semi-circular cross-section is formed circumferentially at the connection openings 93. This has the advantage that no material of the second plate 65 melted down in the connection openings 93 in the intermediate space 73, i.e. in particular in the connection channel 89, for example in the form of material spatters, is deposited, for example.

For this complete transfer and remelting of the material of the second plate 65 melted by means of the laser beam 74, the parameters of the laser beam 74 and thus also of the focal spot of the laser beam 74 on the outer side 67 of the first plate 64 are selected accordingly: a power of 500 W with a spot size of 300 μm, a relative velocity v of 500 mm/sec between the first plate 64 and the laser beam 74 during forming of the connection opening 93 and a thickness of the first plate 64 in the area of the connection opening of 75 μm. The position of the laser beam 74 on the first plate 64 is optically captured with a laser scanner of the laser system. Due to the known geometry of the second plate 65 and the welded joint 69 already made between the first and second plates 64, 65, the data of the geometry of the first and/or second plates 64, 65 and the result of the optical detection of the laser beam 74 may be directed exactly to the correct positions for forming the connection openings 93. If the width of the slot-shaped connection openings 100 is greater than the spot size of the laser beam 74, the latter is guided several times in the longitudinal direction along the slot-shaped connection openings 100 for multiple melting, cutting and rearranging of the material of the first plate 64.

In FIG. 17, a second exemplary embodiment of the configuration of the connection openings 93 is shown as slot-shaped connection openings 100. In the following, substantially only the differences compared to the first exemplary embodiment according to FIGS. 15 and 16 are described. The slot-shaped connection openings 93 are not horizontally but approximately vertically aligned, i.e., approximately at a right angle to the first exemplary embodiment.

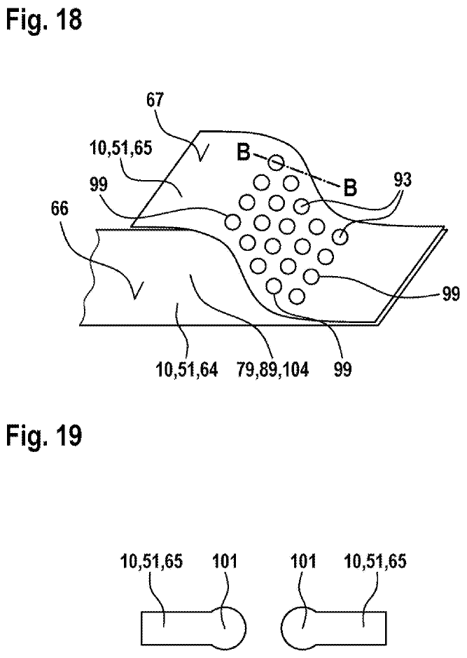

In FIGS. 18 and 19, a third exemplary embodiment of the configuration of the connection openings 93 is shown. In the following, substantially only the differences compared to the first exemplary embodiment according to FIGS. 15 and 16 are described. The connection openings 93 are substantially circular.

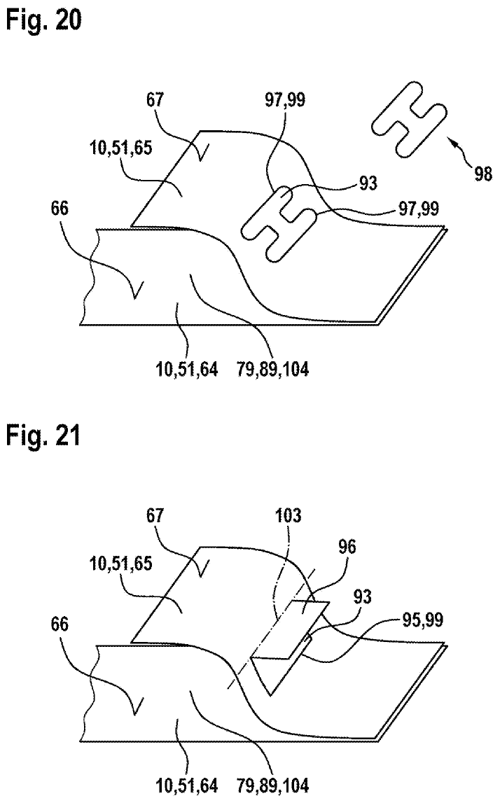

In FIG. 20, a fourth exemplary embodiment of the configuration of the connection openings 93 is shown. In the following, substantially only the differences compared to the first exemplary embodiment according to FIGS. 15 and 16 are described. The connection opening 93 is substantially H-shaped. In this case, the material of the first plate 64 is not completely remelted by means of the laser beam 74 during forming, but is merely cut and remelted along a completely circumferential recess geometry 97 as the remelting geometry 99 and a sub-area 98 of the second plate 65 is withdrawn from the connection opening 93.

In FIG. 21, a fifth exemplary embodiment of the configuration of the connection openings 93 is shown. In the following, substantially only the differences compared to the first exemplary embodiment according to FIGS. 15 and 16 are described. The connection opening 93 is substantially rectangular. In this case, the material of the second plate 65 is not entirely remelted during forming by means of the laser beam 74, but is merely cut and remelted along a U-shaped, not completely circumferential flap geometry 95 as the remelting geometry 99, and a sub-area as flap 96 of the second plate 65 is pivoted outwardly about a pivot axis 103 as a section that has not been cut. Prior to stacking the second plate 65 on the first plate 64, a residual stress and/or pretensioning was mechanically introduced into the second plate 65 by means of an embossing process, so that the flap 96 automatically pivots outwards after the formation of the U-shaped cut.

Overall, the method according to the invention for manufacturing the bipolar plate 10, the method according to the invention for manufacturing the electrochemical cell unit 53, and the electrochemical cell unit 53 according to the invention have significant advantages. The connection openings 93 on the connection channels 89 are formed with the laser 73 after establishing the material-locking connection between the first and second plates 64, 65 as a bipolar plate 10. Forming with the laser 73 has the advantage that the connection openings 93 can be formed very accurately and with little effort and low cost, because a laser system for generating the laser beam 73 for the production of the weld seams 70 is available anyway. Elaborate mechanical punching of the connection openings 93 with a costly punching machine for providing the second plates 65 is thus not necessary. The costs for manufacturing the bipolar plates 10 can thus be advantageously reduced with a higher accuracy of the geometry of the connection openings 93. In addition, even very small connection openings 93 may be formed, which cannot be produced using mechanical punching processes for reasons of manufacturing accuracy and material technology. Thus, a large number of connection openings 93 may be formed or be formed in each connection channel 89. Changes to the geometry of the connection openings 93 may be achieved inexpensively with little effort only with a change of the software and/or reprogramming of the laser system, such that the laser beam 74 performs a different motion path on the second plate 65.

1. A method for manufacturing a bipolar plate (10, 51) for an electrochemical cell unit (53) for converting electrochemical energy into electrical energy as a fuel cell unit (1) and/or for converting electrical energy into electrochemical energy as an electrolytic cell unit (49) having stacked electrochemical cells (52), said method comprising the following steps:
providing a first plate (64) and a second plate (65), stacking the first plate (64) and the second plate (65) on top of one another such that inner surfaces (66) of the first and second plate (64, 65) lie on top of one another,
applying contact forces to the first and second plate (64, 65) by negative pressure in a negative pressure chamber (104) relative to an ambient pressure so that, as a result of the contact forces applied by the ambient pressure, the inner surfaces (66) of the first and second plate (64, 65) lie on top of one another with an additional compression force in a contact region (68) due to the applied contact forces,
producing at least one welded joint (69) between the first and second plate (64, 65) by a laser beam (74),
forming connection channels (89) for process fluids in the first and/or the second plate (64, 65), the connection channels opening into fluid openings (41) in the bipolar plates (10, 51) and into channels (12, 13, 14) for process fluids in the bipolar plates (10, 51),
forming connection openings (93) in the first and/or second plate (64, 65) which connect the connection channels (89) to the channels (12, 13, 14) for process fluids in the bipolar plates (10, 51),
wherein
the connection openings (93) are formed in the first and/or second plate (64, 65) by a laser beam (74).

2. The method according to claim 1,
wherein
the welded joint (69) between the first and second plate (64, 65) is produced first and then the connection openings (93) are formed in the first and/or the second plate (64, 65) by the laser beam (74).

3. The method according to claim 1,
wherein
the contact forces to the first and second plate (64, 65) are applied first by negative pressure in the negative pressure chamber (104) relative to the ambient pressure, and subsequently and simultaneously the welded joint (70) between the first and second plate (64, 65) is produced.

4. The method according to claim 1,
wherein
the first and/or second plate (64, 65) are formed by deforming connection channel geometries (102) such that, after stacking the first plate (64) and the second plate (65) on top of one another, the connection channels (89) are configured as an intermediate space (79) between the first and second plate (64, 65).

5. The method according to claim 4,
wherein
forming the connection channel geometries (102) in the first and/or second plate (64, 65) is performed prior to stacking the first plate (64) and the second plate (65) on top of one another.

6. The method according to claim 1,
wherein
a correct position of a focal spot of the laser beam (74) generated by a laser system for forming the connection openings (93) on the first and/or second plate (64, 65) is optically captured.

7. The method according to claim 1,
wherein
at least one connection opening (93) for each connection channel (89) is formed in the first and/or second plate (64, 65) by the laser beam (74) by cutting the first and/or second plate (64, 65) by the laser beam (74) at at least one flap geometry (95) and subsequently moving at least a sub-area of the first and/or second plate (64, 65) as the at least one flap (96).

8. The method according to claim 7,
wherein
the movement of the at least one flap (96) is caused by a residual stress or pretensioning of the first and/or second plate (64, 65).

9. The method according to claim 8,
wherein
the residual stress or pretensioning of the first and/or second plate (64, 65) is introduced into the first and/or second plate (64, 65) with an embossing process.

10. The method according to claim 1,
wherein
at least one connection opening (93) for each connection channel (89) is formed in the first and/or second plate (64, 65) by the laser beam (74) by cutting the first and/or second plate (64, 65) by the laser beam (74) at at least one recess geometry (97) and subsequently removing at least one sub-area (98) of the first and/or second plate (64, 65) from the remaining first and/or second plate (64, 65).

11. The method according to claim 1,
wherein
at least one connection opening (93) for each connection channel (89) is formed in the first and/or second plate (64, 65) by the laser beam (74) by cutting the first and/or second plate (64, 65) by the laser beam (74) at at least one remelting geometry (99) and material of the first and/or second plate (64, 65) melted during cutting is deposited at least partially as a melting lip (101) on an edge of the first and/or second plate (64, 65) which delimits the at least one connection opening (93).

12. The method according to claim 1,
wherein
at least one connection opening (93) is slot-shaped and/or circular and/or T-shaped.

13. The method according to claim 1, one or more of the
wherein
the laser beam (74) for forming the connection openings has a power of between 200 W and 800 W,
and/or
the laser beam (74) for forming the connection openings has a diameter of between 100 μm and 500 μm,
and/or
a relative speed between the first and/or second plate (64, 65) and a focal spot of the laser beam (74) for forming the connection openings is between 300 mm/sec and 700 mm/sec, and/or
a thickness of the first and/or second plate (64, 65) on the focal spot of the laser beam (74) for forming the connection openings is between 25 μm and 125 μm.

14. A method for manufacturing an electrochemical cell unit (53) for converting electrochemical energy into electrical energy as a fuel cell unit (1) and/or for converting electrical energy into electrochemical energy as an electrolytic cell unit (49) having stacked electrochemical cells (52), said method comprising the following steps:
providing layer-shaped components (5, 6, 7, 8, 9, 10, 30, 51) of the electrochemical cells (52), namely proton exchange membranes (5), anodes (7), cathodes (8), gas diffusion layers (9) and bipolar plates (10, 51),
stacking the layered components (5, 6, 7, 8, 9, 10, 30, 51) to form electrochemical cells (52) and a stack of the electrochemical cell unit (53),
wherein
the bipolar plates (10, 51) are provided by performing a method according to claim 1.

15. An electrochemical cell unit (53) for converting electrochemical energy into electrical energy as a fuel cell unit (1) and/or for converting electrical energy into electrochemical energy as an electrolytic cell unit (49) comprising:
stacked electrochemical cells (52), and the electrochemical cells (52) each comprise stacked layered components (5, 6, 7, 8, 9, 10, 51), and the components (5, 6, 7, 8, 9, 10, 51) of the electrochemical cells (52) are proton exchanger membranes (5), anodes (7), cathodes (8), gas diffusion layers (9) and bipolar plates (10, 51), wherein connection channels (89) for process fluids between the first and second plates (64, 65) are configured in the bipolar plates (10, 51) and the connection channels (89) open into fluid openings (41) in the bipolar plates (10, 51) and in channels (12, 13, 14) for process fluids in the bipolar plates (10, 51) and connection openings (93) are configured in the first and/or second plate (64, 65) of the bipolar plates (10, 51), which connect the connection channels (89) to the channels (12, 13, 14) for process fluids in the bipolar plates (10, 51),
wherein
the electrochemical cell unit (53) is manufactured using a method according to claim 14
and/or
the connection openings (93) of melting lips (101) are delimited at the first and/or second plates (64, 65), the melting lips (101) have a greater thickness than the first and/or second plate (64, 65) outside the melting lips (101) and/or the melting lips (101) are configured from melted material of the first and/or second plate (64, 65).

16. The method according to claim 4, wherein the connection channel geometries (102) are formed by embossing.

17. The method according to claim 6, wherein the correct position of a focal spot of the laser beam (74) generated by a laser system for forming the connection openings (93) on the first and/or second plate (64, 65) is optically captured with a laser scanner.

18. The method according to claim 7, wherein moving at least a sub-area of the first and/or second plate (64, 65) as the at least one flap (96) includes pivoting the at least one sub-area.

19. The method according to claim 11, wherein material of the first and/or second plate (64, 65) melted during cutting is deposited completely as a melting lip (101) on the edge of the first and/or second plate (64, 65) which delimits the at least one connection opening (93).

20. The method according to claim 13, wherein
the laser beam (74) for forming the connection openings has a power of between 400 W and 600 W
and/or
the laser beam (74) for forming the connection openings has a diameter of between 200 μm and 400 μm,
and/or
a relative speed between the first and/or second plate (64, 65) and the focal spot of the laser beam (74) for forming the connection openings is between 400 mm/sec and 600 mm/sec,
and/or
the thickness of the first and/or second plate (64, 65) on the focal spot of the laser beam (74) for forming the connection openings is between 50 μm and 100 μm.
